(19) United States
(12) Patent Application Publication
(10) Pub. No.: US 2019/0363940 A1
(43) Pub. Date: Nov. 28, 2019

(54) METHODS, APPARATUSES AND COMPUTER-READABLE MEDIUMS FOR GROUP-BASED SCALABLE NETWORK RESOURCE CONTROLLER CLUSTERS

(71) Applicant: Nokia Solutions and Networks OY, Espoo (FI)

(72) Inventors: Attaullah ZABIHI, Kanata, CA (US); Darren HELMER, Nepean, CA (US); Felix KATZ, Nepean, CA (US)

(73) Assignee: Nokia Solutions and Networks OY, Espoo (FI)

(21) Appl. No.: 15/987,421

(22) Filed: May 23, 2018

(51) Int. Cl. H04L 12/24; H04L 29/08; H04L 29/06; H04L 12/26

(52) U.S. Cl. CPC H04L 41/0893; H04L 67/1004; H04L 41/0806; H04L 43/10; H04L 67/40

(57) ABSTRACT

A network resource controller for controlling at least a first group of network elements from among a plurality of network elements in a network, includes at least one processor and at least one memory including computer program code. The at least one memory and the computer program code are configured to, with the at least one processor, cause the network resource controller to: enter a candidate state for electing a leader for the first group of network elements, the first group of network elements including a subset of network elements from among the plurality of network elements; transition from the candidate state to a leader state for the first group of network elements in response to determining that the network resource controller has been elected the leader for the first group of network elements; and control network elements in the first group of network elements.

### TECHNICAL FIELD

One or more example embodiments relate to distributed network management and/or network mediation systems.

### BACKGROUND

Distributed consensus-based algorithms, such as RAFT, allow for network resource controllers and network elements to operate as coherent groups that are more fault or failure tolerant.

### SUMMARY

At least one example embodiment provides a network resource controller for controlling at least a first group of network elements from among a plurality of network elements in a network, the network resource controller comprising at least one processor and at least one memory including computer program code. The at least one memory and the computer program code are configured to, with the at least one processor, cause the network resource controller to: enter a candidate state for electing a leader for the first group of network elements, the first group of network elements including a subset of network elements from among the plurality of network elements; transition from the candidate state to a leader state for the first group of network elements in response to determining that the network resource controller has been elected the leader for the first group of network elements; and control network elements in the first group of network elements.

At least one other example embodiment provides a network resource controller for controlling at least a first group of network elements from among a plurality of network elements in a network, the network resource controller comprising: at least one processor and at least one memory including computer program code. The at least one memory and the computer program code are configured to, with the at least one processor, cause the network resource controller to: enter a candidate state for electing a leader for the first group of network elements, the first group of network elements including a subset of network elements from among the plurality of network elements; determine whether the network resource controller has been elected leader for the first group of network elements; determine whether to transition from the candidate state to a leader state for the first group of network elements in response to determining that the network resource controller has been elected leader for the first group of network elements and whether acting as leader for the first group of network elements provides load balancing among a cluster of network resource controllers including the network resource controller; transition to the leader state in response to determining that acting as leader for the first group of network elements provides load balancing among the cluster of network resource controllers; and control network elements in the first group of network elements.

According to at least some example embodiments, the first group of network elements may include only the subset of network elements from among the plurality of network elements.

The plurality of network elements may include a plurality of groups of network elements; the at least one memory may store a plurality of states; each of the plurality of states may correspond to a group of network elements from among the plurality of groups of network elements; and each of the plurality of states may be one of the leader state, a follower state, and the candidate state. The plurality of states may be set independently of one another.

The at least one memory and the computer program code may be further configured to, with the at least one processor, cause the network resource controller to: enter a candidate state for electing a leader for a second group of network elements from among the plurality of network elements; determine that another network resource controller has been elected leader for the second group of network elements; and transition from the candidate state to a follower state for the second group of network elements in response to determining that another network resource controller has been elected leader for the second group of network elements. The network resource controller may concurrently exist in the leader state for the first group of network elements and in the follower state for the second group of network elements.

The plurality of network elements may include a plurality of groups of network elements, and each of the plurality of groups of network elements may be identified by a group identifier.

The at least one memory and the computer program code may be further configured to, with the at least one processor, cause the network resource controller to control the network elements in the first group of network elements by: outputting heartbeat messages to the follower network resource controllers for the network elements in the first group of network elements, each of the heartbeat messages including a group identifier identifying the first group of network elements; and exchanging state update messages with the follower network resource controllers for the network elements in the first group of network elements, each of the state update messages including the group identifier.

At least one other example embodiment provides a network resource controller for controlling at least a first group of network elements from among a plurality of network elements in a network, the network resource controller comprising: means for entering a candidate state for electing a leader for the first group of network elements, the first group of network elements including a subset of network elements from among the plurality of network elements; means for transitioning from the candidate state to a leader state for the first group of network elements in response to determining that the network resource controller has been elected the leader for the first group of network elements; and means for controlling network elements in the first group of network elements.

At least one other example embodiment provides a network resource controller for controlling at least a first group of network elements from among a plurality of network elements in a network, the network resource controller comprising: means for entering a candidate state for electing a leader for the first group of network elements, the first group of network elements including a subset of network elements from among the plurality of network elements; means for determining whether the network resource controller has been elected leader for the first group of network elements; means for determining whether to transition from the candidate state to a leader state for the first group of network elements in response to determining that the network resource controller has been elected leader for the first group of network elements and whether acting as leader for the first group of network elements provides load balancing among a cluster of network resource controllers including the network resource controller; means for transitioning to the leader state in response to determining that acting as leader for the first group of network elements provides load balancing among the cluster of network resource controllers; and means for controlling network elements in the first group of network elements.

At least one other example embodiment provides a method for controlling, by a network resource controller, at least a first group of network elements from among a plurality of network elements in a network, the method comprising: entering a candidate state for electing a leader for the first group of network elements, the first group of network elements including a subset of network elements from among the plurality of network elements; transitioning from the candidate state to a leader state for the first group of network elements in response to determining that the network resource controller has been elected leader for the first group of network elements; and controlling network elements in the first group of network elements.

At least one other example embodiment provides a non-transitory computer-readable storage medium including program instructions for causing a network resource controller to perform a method comprising: entering a candidate state for electing a leader for the first group of network elements, the first group of network elements including a subset of network elements from among the plurality of network elements; transitioning from the candidate state to a leader state for the first group of network elements in response to determining that the network resource controller has been elected leader for the first group of network elements; and controlling network elements in the first group of network elements.

According to at least some example embodiments, the first group of network elements may include only the subset of network elements from among the plurality of network elements.

The plurality of network elements may include a plurality of groups of network elements; the network resource controller may have a state corresponding to each group of network elements from among the plurality of groups of network elements; and each state may be one of the leader state, a follower state, and the candidate state. Each state may be set independently of other states.

The method may further include: entering a candidate state for electing a leader for a second group of network elements from among the plurality of network elements; determining that another network resource controller has been elected leader for the second group of network elements; and transitioning from the candidate state to a follower state for the second group of network elements in response to determining that another network resource controller has been elected leader for the second group of network elements; wherein the network resource controller concurrently exists in the leader state for the first group of network elements and in the follower state for the second group of network elements.

The plurality of network elements may include a plurality of groups of network elements, and each of the plurality of groups of network elements may be identified by a group identifier.

The controlling may include: outputting heartbeat messages to the network resource controllers for the network elements in the first group of network elements, each of the heartbeat messages including a group identifier identifying the first group of network elements; and exchanging state update messages with the network resource controllers for the network elements in the first group of network elements, each of the state update messages including the group identifier.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a block diagram illustrating an example of a portion of a network including a sub-cluster of network resource controllers and a plurality of network elements;

FIG. 2 is a flow chart illustrating a method according to an example embodiment;

FIG. 3 is a flow chart illustrating another method according to an example embodiment;

FIG. 4 is a flow chart illustrating another method according to an example embodiment; and

FIG. 5 provides a general architecture and functionality suitable for implementing functional elements, or portions of functional elements, described herein.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

Accordingly, it should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

One or more example embodiments introduce groups of network elements and RAFT sub-clusters of network resource controllers (also sometimes referred to herein as network mediators or network mediation servers), wherein a sub-cluster of network resource controllers (from among a larger cluster of network resource controllers in the network) is responsible for control or mediation of a plurality of network elements in a portion of a network. A sub-cluster may also be referred to herein as a cluster.

A network resource controller (NRC) is a control/management entity (e.g., a software, hardware or combination software and hardware entity) that is responsible for control/management of a portion of a network. More specifically, for example, network resource controllers are responsible for network discovery, network monitoring, and affecting changes (e.g., creation, deletion or modification of network connectivity, such as service, tunnels, flows, or the like) in the network. Network resource controllers also provide services to various applications that require knowledge about the network or modify components of the network.

A network element (NE) is a network component (e.g., a bridge, switch, router, etc.) that provides one or more networking functions (e.g., switching, bridging, routing, multiplexing, aggregation, or the like) for a variety of types of network traffic. A network element may be a physical component (e.g., running on dedicated and sometimes specialized hardware referred to as “a box”) or a virtual network element (e.g., running on a generic virtual machine and implementing networking functions in software). Network elements may be communicatively coupled to one another via wired or wireless links (e.g., communication pipes, which may be physical or virtual/logical).

According to at least one example embodiment, the plurality of network elements in the portion of the network assigned to a sub-cluster of network resource controllers are divided into groups, such that each network element is assigned to one group. A RAFT election is held for each of the groups to identify a network resource controller, from among the sub-cluster, as a leader for each respective group. Each group of network elements may include only a subset (e.g., less than all) of the plurality of network elements in the portion of the network. The network resource controllers in the sub-cluster that are not elected as a leader for a respective group of network elements serve as followers for the group. According to at least some example embodiments, each of the groups of network elements is identified by a group identifier, which is included in each message (e.g., heartbeat, Remote Procedure Calls (RPCs), etc.) transmitted by the network resource controllers.

According to one or more example embodiments, a network resource controller may simultaneously or concurrently be the leader for one or more groups of network elements and a follower for other groups controlled by network resource controllers in the sub-cluster. Accordingly, a network resource controller may concurrently exist in the leader state for one or more groups of network elements, in the follower state for another one or more groups of network elements, and/or in the candidate state for yet another one or more groups of network elements. A current state (e.g., leader, follower or candidate) of a network resource controller with regard to a group of network elements may be stored in a memory.

A network resource controller elected as a leader for a respective group of network elements actively uses its CPU resources (performing mediation or other functions discussed herein) for the respective group (or groups), while providing redundancy via state replication with regard to the groups for which the network resource controller is a follower.

State replication is performed based on the group (from the leader of the sub-cluster to each of its followers). Within the larger cluster of network resource controllers, which may include a plurality of sub-clusters, each network resource controller holds the state or states for only the network elements in the groups it controls (e.g., for which the network resource controller is a leader or a follower), rather than for the entire network. As a result, CPU load may be more evenly distributed throughout the cluster of network resource controllers while reducing memory requirements for each cluster member. As a result, network resource controller cluster scalability limits may be increased.

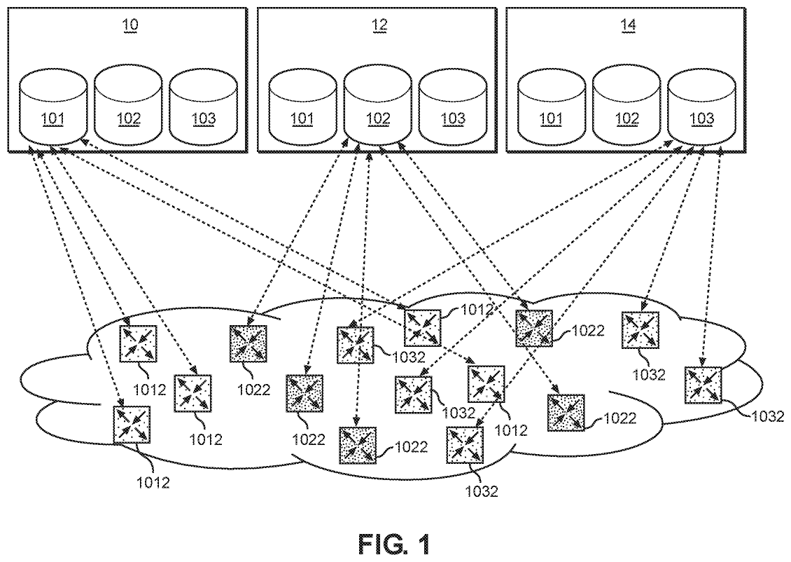

FIG. 1 is a block diagram illustrating an example of a portion of a network including a sub-cluster of network resource controllers and a plurality of network elements.

Referring to FIG. 1, the portion of the network includes a sub-cluster of network resource controllers (also sometimes referred to herein as network mediation servers) 10, 12 and 14, and a plurality of network elements 1012, 1022 and 1032. In this example, the sub-cluster of network resource controllers 10, 12 and 14 is a RAFT sub-cluster of network resource controllers. However, example embodiments are not limited to this example embodiment. Rather, example embodiments may be applicable to other consensus based algorithms.

Although not shown, the sub-cluster may be part of a larger cluster of network resource controllers including a plurality of sub-clusters. Similarly, the plurality of network elements may be a portion of a larger plurality of network elements in the network.

The plurality of network elements 1012, 1022 and 1032 are arranged into groups (also referred to as sets), and the sub-cluster of network resource controllers is responsible for control or mediation of the groups of network elements. In the example embodiment shown in FIG. 1, network elements 1012 belong to, and will be referred to herein, as a first group of network elements 1012, network elements 1022 belong to, and will be referred to herein, as a second group of network elements 1022, and network elements 1032 belong to, and will be referred to herein, as a third group of network elements 1032. Although only three groups of network elements and three network resource controllers are shown in FIG. 1, example embodiments are not limited to this example. Rather, there may be any number of network resource controllers in a sub-cluster, and any number of network elements under the control of the sub-cluster of network resource controllers.

In the example shown in FIG. 1, each of the network resource controllers 10, 12 and 14 includes a datastore corresponding to each of the plurality of groups of network elements to enable each of the network resource controllers to function as a leader and a follower for different groups concurrently or simultaneously. The first datastore 101 stores information associated with the first group of network elements 1012, the second datastore 102 stores information associated with the second group of network elements 1022, and the third datastore 103 stores information associated with the third group of network elements 1032. The datastores 101, 102 and 103 may be included in one or more memories at each of the network resource controllers 10, 12 and 14.

A datastore for a given group of network elements stores configuration and state information for all network elements belonging to the group. For a given group of network elements, the datastore also stores network services information, tunnel information, flow information, or the like, along with information regarding network resources used by the network services, tunnels, flows, or the like. In response to a relevant change in the network (e.g., failure or provisioning of ports, cards, network elements, or the like, route advertisement, changes to services, tunnels, or flows, etc.), the network resource controller updates the corresponding datastore to accurately reflect network information. In one example, a datastore may be implemented as a transactional database (DB), a relational database management system (RDBMS), graph database, key value store, etc.

Although the example embodiment in FIG. 1 illustrates each network resource controller as including datastores 101, 102 and 103, example embodiments should not be limited to this example. Rather, each network resource controller may include a datastore corresponding to one or more groups of network elements.

As RAFT servers, the network resource controllers 10, 12 and 14 may communicate using remote procedure calls (RPCs). In one example, the RPCs may include RequestVote RPCs and AppendEntries RPCs. In contrast to standard RPCs, according to one or more example embodiments messages sent between network resource controllers include a group identification or identifier (e.g., group ID) identifying the group of network elements to which the message or command is associated. Each message may include the group ID used by the network resource controller both during the election of the group leader and subsequent heartbeat and state propagation from the group leader to its followers. In one example, the group identifier (e.g., groupID) identifying the group of network elements to which the message pertains may be included in addition to term information, log information (e.g., lastLogIndex and lastLogTerm), and server information (e.g., serverID). In one example, the group identifier may be a number uniquely identifying the group. The number may be generated by an external entity (network element controller) and assigned to all network resource controllers for the group.

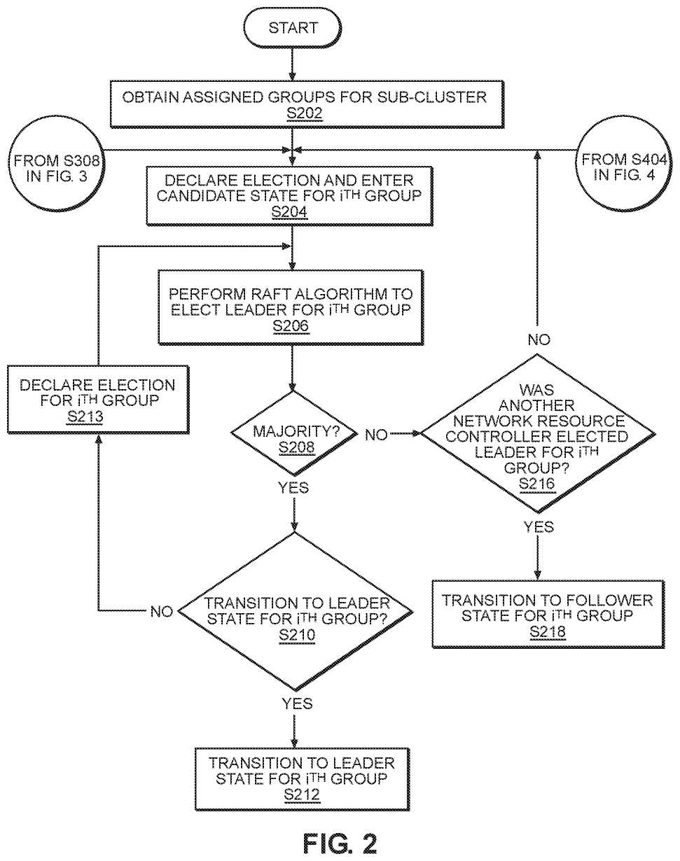

FIG. 2 is a flow chart illustrating a method according to an example embodiment. For the sake of clarity, the example embodiment shown in FIG. 2 will be discussed with regard to the network resource controller 10 and the first group of network elements 1012 shown in FIG. 1 in response to initiation (or power-up) of the network resource controller 10. However, it should be understood that example embodiments may apply to the network resource controllers 12 and 14 as well as the other groups of network elements 1022 and 1032. Additionally, the method shown in FIG. 2 may be initiated in response to other events, such as network resource controller failure, or the like. Although the method of FIG. 2 will be discussed with regard to the first group of network elements 1012 for example purposes, FIG. 2 refers to the more generic i^{th} group of network elements since this method may be performed for each of the plurality of groups assigned to a given sub-cluster of network resource controllers.

According to at least some example embodiments, the method shown in FIG. 2 may be performed independently for each of the plurality of groups of network elements such that a leader is elected for each of the plurality of groups of network elements independently. Moreover, elections for each of the plurality of groups of network elements may occur concurrently or simultaneously, and each of the plurality of network resource controllers may have a state corresponding to each of the plurality of groups of network elements, rather than a single state for all of the plurality of network elements. The state for each of the plurality of groups may be one of a leader, a candidate or a follower state. The state for each of the plurality of groups may be different. As a result, each of the plurality of network resource controllers may act as a leader or a follower for each of the plurality of groups of network elements.

Referring to FIG. 2, at step S202 the network resource controller 10 obtains the groups of network elements assigned to the sub-cluster of network resource controllers 10, 12 and 14. In one example, the network resource controller 10 may obtain the assigned groups of network elements from a network element controller (NEC, not shown) at power up or initialization into the network. Given a required level of network resource controller redundancy, the network element controller may assign network elements to respective groups and respective groups to respective sub-clusters of network resource controllers using various algorithms. For example, the network element controller may assign network elements to respective groups and respective groups to respective sub-clusters of network resource controllers in an effort to have approximately the same number of network elements controlled by each sub-cluster of network resource controllers, or by taking into account the “weight” (e.g., complexity) of the network elements (e.g., larger routers or optical switches weigh more than simpler access switches) and the resources of the network resource controllers (e.g., memory, disk space, CPU resources, etc.).

At step S204, the network resource controller 10 declares a RAFT election for the first group of network elements 1012, and enters (or transitions to) the candidate state (also sometimes referred to as the election state) for the first group of network elements 1012.

At step S206, the network resource controller 10 performs a standard RAFT algorithm to elect a leader for the first group of network elements 1012. In so doing, the network resource controller 10 votes for itself and issues RequestVote RPCs in parallel to each of network resource controllers 12 and 14 in the sub-cluster. As mentioned above, the RPCs as well as other messages/commands issued by the network resource controller 10 include a group identifier in addition to the information associated with the standard RAFT algorithm messages. In this instance, the group identifier identifies the first group of network elements 1012.

If the network resource controller 10 receives a majority of votes during the election (step S208), then the network resource controller 10 determines whether to accept the leadership role for the first group of network elements 1012 and transition from the candidate state to the leader state for the first group of network elements 1012 at step S210. In one example, in response to receiving a majority of the votes during the election, the network resource controller 10 determines whether to accept the leadership role for the first group of network elements 1012 based on a current load on the network resource controller 10 relative to current loads on the other network resource controllers 12 and 14 in the sub-cluster. That is, for example, the network resource controller 10 determines whether acting as a leader of the first group of network elements 1012 provides load balancing among the sub-cluster of network resource controllers. In one example, the network resource controller 10 may make this decision based on the number of groups for which the network resource controller is already a leader, the size and complexity of these groups (e.g., number of network elements in the groups, the complexity of the network elements in the group, etc.), and/or also computing resources (e.g., number of CPUs and their utilization level, volatile and/or non-volatile memory, etc.) available to the network resource controller.

If the network resource controller 10 receives a majority of the votes during the election, but determines that network resource controller 12 or 14 has a state that is as up-to-date as the state of the network resource controller 10 and is also currently less loaded, then the network resource controller 10 may decide not to accept the leadership role for the first group of network elements 1210 at step S210. Otherwise, the network resource controller 10 may decide to accept the leadership role for the first group of network elements 1210.

Still referring to FIG. 2, if the network resource controller 10 decides not to accept the leadership role at step S210, then the network resource controller 10 declares another election for the first group of network elements 1210 at step S213. The process then returns to step S206 and continues as discussed herein.

Returning to step S210, if the network resource controller 10 decides to accept the leadership role for the first group of network elements 1210, then the network resource controller 10 transitions from the candidate state to the leader state for the first group of network elements 1012 at step S212. The network resource controller 10 then operates as a leader for the first group of network elements 10, and the network resource controllers 12 and 14 transition from the candidate state to the follower state.

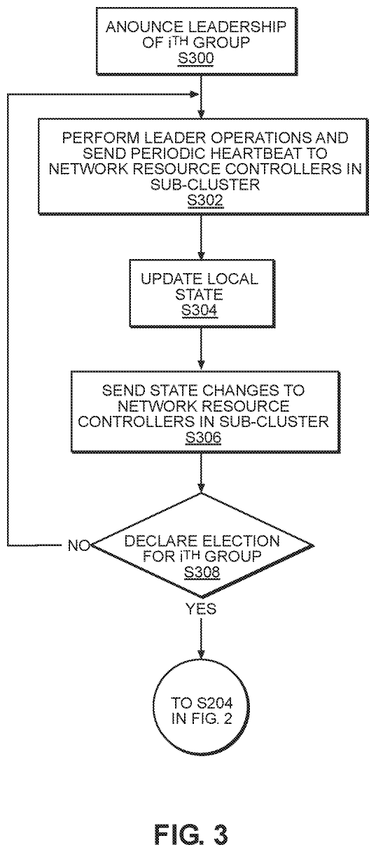

Example operation of the network resource controller 10 in the leader state is discussed in more detail below with regard to FIG. 3.

Returning to step S208, if the network resource controller 10 does not receive a majority of the votes during the election, then at step S216 the network resource controller 10 determines whether another network resource controller (e.g., 12 or 14) in the sub-cluster has been elected as the leader for the first group of network elements 1012. In one example, the network resource controller 10 determines that another network resource controller in the sub-cluster has been elected leader for the first group of network elements 1012 if a heartbeat is received from another of the network resource controllers in the sub-cluster.

If the network resource controller 10 determines that another network resource controller in the sub-cluster has not been elected leader of the group of network elements 1012 at step S216, then the process returns to step S204, another election is held, and the process continues as discussed herein.

Returning to step S216, if the network resource controller 10 determines that another network resource controller in the sub-cluster has been elected leader for the group of network elements 1012 at step S216, then at step S218 the network resource controller 10 transitions from the candidate state to the follower state for the group of network elements 1012.

After transitioning to the follower state at step S218, the network resource controller 10 operates as a follower with regard to the group of network elements 1012 until a new election is held, and the network resource controller 10 is elected as a leader with regard to the group of network elements 1012. In the follower state, the network resource controller 10 is passive, and does not issue any requests. The network resource controller 10 simply responds to requests from network resource controllers in the leader and candidate states. For example, as a follower, the network resource controller 10 receives datastore changes for the first group of network elements 1012 from the leader (e.g., network resource controller 12 or 14), and updates the first datastore 101 for the first group of network elements 1012; provides a query service for the first datastore 101 to offload the leader network resource controller; participates in the leader elections and maintains readiness (e.g., through maintaining an updated datastore 101) to take over the leadership role for the first group of network elements 1012 when necessary or appropriate.

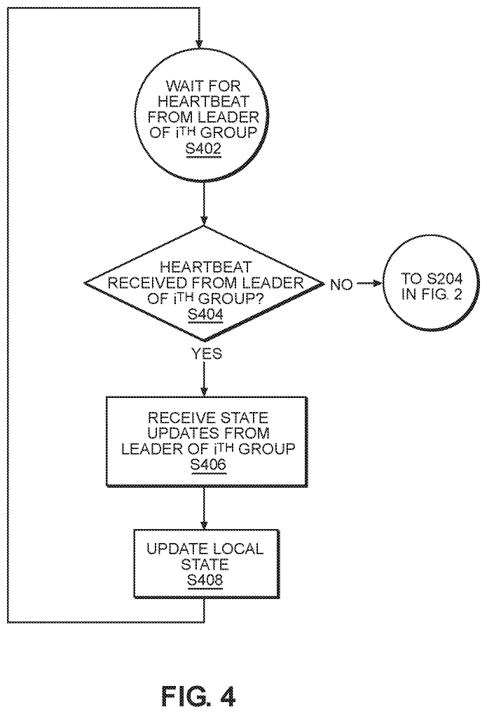

Example operation of the network resource controller 10 in the follower state for the group of network elements 1012 is discussed in more detail below with regard to FIG. 4.

As discussed above, each network resource controller may perform the example embodiment shown in FIG. 2 for each of the plurality of groups of network elements 1012, 1022 and 1032. For example, the network resource controller 10 may transition to the leader state or the follower state for the first group of network elements 1012 by performing a first iteration of the method shown in FIG. 2, transition to the leader state or the follower state for the second group of network elements 1022 by performing a second iteration of the method shown in FIG. 2, and transition to the leader state or the follower state for the third group of network elements 1032 by performing a third iteration of the method shown in FIG. 2. Alternatively, the network resource controller 10 may perform the method shown in FIG. 2 concurrently or simultaneously for each of the first group of network elements 1012, the second group of network elements 1022 and the third group of network elements 1032.

FIG. 3 is a flow chart illustrating another method according to an example embodiment. The method shown in FIG. 3 illustrates example operation of a network resource controller in the leader state, according to an example embodiment. As with the example embodiment shown in FIG. 2, the example embodiment shown in FIG. 3 will be described with regard to the network resource controller 10 and the first group of network elements 1012. However, it should be understood that example embodiments may be applicable to the network resource controllers 12 and 14.

Referring to FIG. 3, at step S300 the network resource controller 10 announces its election as leader of the first group of network elements 1012 by sending a heartbeat message to the other network resource controllers 12 and 14 in the sub-cluster. In one example, the heartbeat message may be an AppendEntries RPC that carries no log entries. As mentioned above, the heartbeat message (e.g., the AppendEntries RPC) may include, among other information, the group identifier identifying the first group of network elements 1012.

At step S302, the network resource controller 10 then performs leader operations for the first group of network elements 1012, and sends periodic heartbeat messages to the follower network resource controllers 12 and 14 in the sub-cluster.

For example, at step S302, as leader of the first group of network elements 1012, the network resource controller 10 may exchange state update messages with the first group of network elements 1012. In more detail, for example, the network resource controller 10 may exchange state update messages with the first group of network elements 1012 to: discover network elements and links; obtain information about the network elements and links to be stored in the first datastore 101; maintain synchronization with the network changes (e.g., receive notifications or fetch updated network information and update the first datastore 101); track network resource utilization (e.g., bandwidth consumed/available on ports) of the network elements; provide mediation to the network for client applications (e.g., propagate changes requested by the applications to the network elements); provide network tunnels/services life cycle control (e.g., find an optimal route for a tunnel, create the tunnel in the network, and modify or delete the tunnel when necessary), or the like. As mentioned above, each of the state update messages includes a group identifier identifying the first group of network elements 1012. As a leader, the network resource controller 10 may also provide a query service for the first datastore 101.

As the local state for the first group of network elements 1012 changes, the network resource controller 10 updates its local state for the group of network elements 1012 in the first datastore 101 at step S304, and sends (or propagates) the state changes to the first datastore 101 at each of the follower network resource controllers 12 and 14 at step S306. In response to receiving the state changes, the follower network resource controllers 12 and 14 update their local states for the first group of network elements 1012 in their respective datastores 101.

At step S308, the network resource controller 10 determines whether to declare another election for the first group of network elements 1012. In one example, the network resource controller 10 may determine whether to declare another election if one or more of the following conditions are met: the network resource controller becomes overloaded (e.g., short of memory, long and growing message queues, etc.), the total number or size of the groups for which the network resource controller is a leader has increased, etc. Example embodiments should not, however, be limited to these example conditions.

If the network resource controller 10 determines that another election for the group of network elements is necessary at step S308, then the process returns to step S204 in FIG. 2, and continues as discussed above.

Returning to step S308, if another election for the first group of network elements 1012 is not yet necessary, then the process returns to step S302, and continues as discussed above.

FIG. 4 is a flow chart illustrating another method according to an example embodiment. The method shown in FIG. 4 illustrates example operation of a network resource controller in the follower state, according to an example embodiment. As with the example embodiment shown in FIG. 2, the example embodiment shown in FIG. 4 will be described with regard to the network resource controller 10 and the first group of network elements 1012. However, it should be understood that example embodiments may applicable to the network resource controllers 12 and 14 and the other groups of network elements 1022 and 1032.

Referring to FIG. 4, after transitioning to the follower state, at step S402 the network resource controller 10 waits for a heartbeat from the elected leader (e.g., network resource controller 12 or 14) for the first group of network elements 1012.

If the network resource controller 10 does not receive a heartbeat from the elected leader within a threshold time interval after transitioning to the follower state (election timeout, S404), then the process returns to step S204 in FIG. 2, wherein the network resource controller 10 declares another election and transitions from the follower state to the candidate state. The process then continues as discussed above with regard to FIG. 2. According to at least one example embodiment, the threshold time interval may be assigned randomly (e.g., between about 150 ms-300 ms), and may be different from that of other network resource controllers in the sub-cluster or other sub-clusters in the larger cluster of network resource controllers.

Returning to step S404, if the network resource controller 10 receives a heartbeat from the elected leader within the threshold time interval after transitioning to the follower state, then the network resource controller 10 receives state updates from the elected leader at step S406, and updates the local states for the first group of network elements 1012 in its first datastore 101 based on the received state updates from the leader at step S408.

The process then returns to step S402 and the network resource controller 10 continues to operate as discussed herein with regard to FIG. 4.

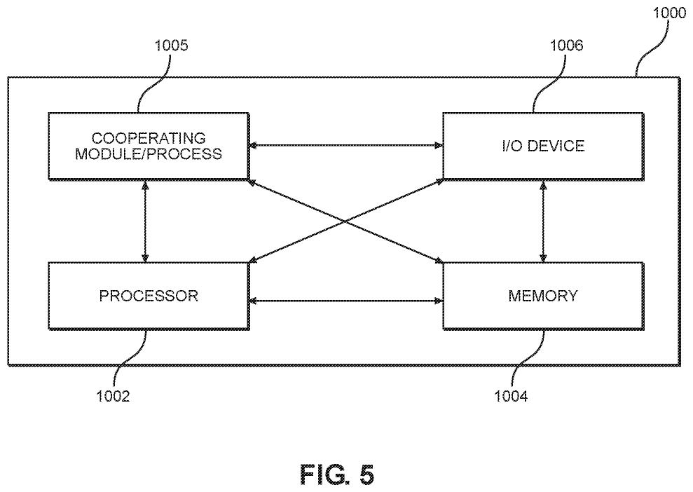

FIG. 5 depicts a high-level block diagram of a computer or computing device suitable for use in implementing, for example, the network resource controllers shown in FIG. 1. Although not specifically described herein, the general architecture and functionality shown in FIG. 5 may also be suitable for implementing one or more other network elements discussed herein.

Referring to FIG. 5, the computer 1000 includes one or more processors 1002 (e.g., a central processing unit (CPU) or other suitable processor(s)) and a memory 1004 (e.g., random access memory (RAM), read only memory (ROM), and the like). The computer 1000 also may include a cooperating module/process 1005. The cooperating process 1005 may be loaded into memory 1004 and executed by the processor 1002 to implement functions as discussed herein and, thus, cooperating process 1005 (including associated data structures) may be stored on a computer readable storage medium (e.g., RAM memory, magnetic or optical drive or diskette, or the like).

The computer 1000 also may include one or more input/output devices 1006 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

While one or more example embodiments will be described from the perspective of the network elements or network resource controllers, it will be understood that one or more example embodiments discussed herein may be performed by the one or more processors (or processing circuitry) at the applicable device. For example, according to one or more example embodiments, at least one memory may include or store computer program code, and the at least one memory and the computer program code may be configured to, with at least one processor, cause a network element or network resource controller to perform the operations discussed herein.

It will be appreciated that a number of the embodiments may be used in combination.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing network elements, network resource controllers, network mediation servers, clients, routers, gateways, nodes, computers, cloud-based servers, web servers, application servers, proxies or proxy servers, or the like. As discussed later, such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network resource controller to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having”, as used herein, are defined as comprising (i.e., open language). The term “coupled”, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, network elements, network resource controllers, network mediation servers, clients, routers, gateways, nodes, computers, cloud-based servers, web servers, application servers, proxies or proxy servers, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

The network elements, network resource controllers, network mediation servers, clients, routers, gateways, nodes, computers, cloud-based servers, web servers, application servers, proxies or proxy servers, or the like, may also include various interfaces including one or more transmitters/receivers connected to one or more antennas, a computer readable medium, and (optionally) a display device. The one or more interfaces may be configured to transmit/receive (wireline and/or wirelessly) data or control signals via respective data and control planes or interfaces to/from one or more network elements, such as network resource controllers, network mediation servers, clients, routers, gateways, nodes, computers, cloud-based servers, web servers, application servers, proxies or proxy servers, or the like.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1.-20. (canceled)

21. A network resource controller for controlling at least a first group of network elements from among a plurality of network elements in a network, the network resource controller comprising:
at least one processor; and
at least one memory including computer program code, the at least one memory and the computer program code configured to, with the at least one processor, cause the network resource controller to
enter a candidate state for electing a leader for the first group of network elements, the first group of network elements including a subset of network elements from among the plurality of network elements,
transition from the candidate state to a leader state for the first group of network elements in response to determining that the network resource controller has been elected the leader for the first group of network elements, and
control network elements in the first group of network elements.

22. The network resource controller of claim 21, wherein the first group of network elements includes only the subset of network elements from among the plurality of network elements.

23. The network resource controller of claim 21, wherein
the plurality of network elements includes a plurality of groups of network elements;
the at least one memory stores a plurality of states;
each of the plurality of states corresponds to a group of network elements from among the plurality of groups of network elements; and
each of the plurality of states is one of the leader state, a follower state, and the candidate state.

24. The network resource controller of claim 23, wherein the plurality of states are set independently of one another.

25. The network resource controller of claim 21, wherein the at least one memory and the computer program code are further configured to, with the at least one processor, cause the network resource controller to
enter a candidate state for electing a leader for a second group of network elements from among the plurality of network elements,
determine that another network resource controller has been elected leader for the second group of network elements, and
transition from the candidate state to a follower state for the second group of network elements in response to determining that another network resource controller has been elected leader for the second group of network elements, wherein
the network resource controller concurrently exists in the leader state for the first group of network elements and in the follower state for the second group of network elements.

26. The network resource controller of claim 21, wherein
the plurality of network elements includes a plurality of groups of network elements, and
each of the plurality of groups of network elements is identified by a group identifier.

27. The network resource controller of claim 21, wherein the at least one memory and the computer program code are further configured to, with the at least one processor, cause the network resource controller to control the network elements in the first group of network elements by
outputting heartbeat messages to other network resource controllers for the first group of network elements, each of the heartbeat messages including a group identifier identifying the first group of network elements, and
exchanging state update messages with the other network resource controllers for the first group of network elements, each of the state update messages including the group identifier.

28. A network resource controller for controlling at least a first group of network elements from among a plurality of network elements in a network, the network resource controller comprising:
at least one processor; and
at least one memory including computer program code, the at least one memory and the computer program code configured to, with the at least one processor, cause the network resource controller to
enter a candidate state for electing a leader for the first group of network elements, the first group of network elements including a subset of network elements from among the plurality of network elements,
determine whether the network resource controller has been elected leader for the first group of network elements,
determine whether to transition from the candidate state to a leader state for the first group of network elements in response to determining that the network resource controller has been elected leader for the first group of network elements and whether acting as leader for the first group of network elements provides load balancing among a cluster of network resource controllers including the network resource controller,
transition to the leader state in response to determining that acting as leader for the first group of network elements provides load balancing among the cluster of network resource controllers, and
control network elements in the first group of network elements.

29. The network resource controller of claim 28, wherein the first group of network elements includes only the subset of network elements from among the plurality of network elements.

30. The network resource controller of claim 28, wherein
the plurality of network elements includes a plurality of groups of network elements;
the at least one memory stores a plurality of states;
each of the plurality of states corresponds to a group of network elements from among the plurality of groups of network elements; and
each of the plurality of states is one of the leader state, a follower state, and the candidate state.

31. The network resource controller of claim 30, wherein the plurality of states are set independently of one another.

32. The network resource controller of claim 28, wherein
the plurality of network elements includes a plurality of groups of network elements, and
each of the plurality of groups of network elements is identified by a group identifier.

33. The network resource controller of claim 28, wherein the at least one memory and the computer program code are further configured to, with the at least one processor, cause the network resource controller to control the network elements in the first group of network elements by
outputting heartbeat messages to other network resource controllers among the cluster of network resource controllers, each of the heartbeat messages including a group identifier identifying the first group of network elements, and
exchanging state update messages with the other network resource controllers among the cluster of network resource controllers, each of the state update messages including the group identifier.

34. A method for controlling, by a network resource controller, at least a first group of network elements from among a plurality of network elements in a network, the method comprising:
entering a candidate state for electing a leader for the first group of network elements, the first group of network elements including a subset of network elements from among the plurality of network elements;
transitioning from the candidate state to a leader state for the first group of network elements in response to determining that the network resource controller has been elected leader for the first group of network elements; and
controlling network elements in the first group of network elements.

35. The method of claim 34, wherein the first group of network elements includes only the subset of network elements from among the plurality of network elements.

36. The method of claim 34, wherein
the plurality of network elements includes a plurality of groups of network elements;
the network resource controller has a state corresponding to each group of network elements from among the plurality of groups of network elements; and
each state is one of the leader state, a follower state, and the candidate state.

37. The method of claim 36, wherein each state is set independently of other states.

38. The method of claim 34, further comprising:
entering a candidate state for electing a leader for a second group of network elements from among the plurality of network elements;
determining that another network resource controller has been elected leader for the second group of network elements; and
transitioning from the candidate state to a follower state for the second group of network elements in response to determining that another network resource controller has been elected leader for the second group of network elements; wherein
the network resource controller concurrently exists in the leader state for the first group of network elements and in the follower state for the second group of network elements.

39. The method of claim 34, wherein
the plurality of network elements includes a plurality of groups of network elements, and
each of the plurality of groups of network elements is identified by a group identifier.

40. The method of claim 34, wherein the controlling comprises:
outputting heartbeat messages to other network resource controllers for the first group of network elements, each of the heartbeat messages including a group identifier identifying the first group of network elements; and
exchanging state update messages with the other network resource controllers for the first group of network elements, each of the state update messages including the group identifier.
